(19) United States
(12) Patent Application Publication
(10) Pub. No.: US 2024/0211768 A1
(43) Pub. Date: Jun. 27, 2024

(54) SIGNALING OF TRAINING POLICIES

(71) Applicant: Telefonaktiebolaget LM Ericsson (publ), Stockholm (SE)

(72) Inventors: Henrik Rydén, Stockholm (SE); Ali Parichehrehteroujeni, Linköping (SE); Luca Lunardi, Genoa (IT); Pradeepa Ramachandra, Linköping (SE); Angelo Centonza, Granada (ES); Paul Schliwa-Bertling, Ljungsbro (SE); Philipp Bruhn, Aachen (DE)

(21) Appl. No.: 18/288,415

(22) PCT Filed: Apr. 28, 2021
(86) PCT No.: PCT/EP2021/061110

§ 371 Date: Oct. 26, 2023

(51) Int. Cl. G06N 3/092

(52) U.S. Cl. CPC G06N 3/092

(57) ABSTRACT

Systems and methods are disclosed herein that relate to influencing training of a Machine Learning (ML) model based on a training policy provided by an actor node are disclosed herein. In one embodiment, a method performed by a first node for training a ML model comprises receiving a training policy for a ML model from a second node, the training policy comprising information that indicates two or more accuracy or importance metrics for two or more ranges of values for a variable to be predicted by the ML model. The method further comprises training the ML model based on a training dataset and the training policy. In one embodiment, the first node is either a training and inferring node or a training node that operates to train the ML model, and the second node is an actor node to which predictions made using the ML model are to be provided.

### TECHNICAL FIELD

The present disclosure relates to training of a Machine Learning (ML) model.

### BACKGROUND

The current architecture of the Fifth Generation (5G) Radio Access Network (RAN), which is also referred to as the Next Generation RAN (NG-RAN), is depicted in FIG. 1 and described in Third Generation Partnership Project (3GPP) Technical Specification (TS) 38.401 v15.4.0.

The NG-RAN architecture can be further described as follows. The NG-RAN consists of a set of New Radio (NR) base stations (gNBs) connected to the Fifth Generation Core (5GC) through the NG interface. A gNB can support Frequency Division Duplexing (FDD) mode, Time Division Duplexing (TDD) mode, or dual mode operation. gNBs can be interconnected through the Xn interface. A gNB may consist of a Central Unit (CU), which is also referred to as a gNB-CU, and one or more Distributed Units (DUs), which are also referred to as gNB-DUs. A gNB-CU and a gNB-DU are connected via the F1 logical interface. One gNB-DU is generally connected to only one gNB-CU. However, for resiliency, a gNB-DU may be connected to multiple gNB-CUs by appropriate implementation. NG, Xn, and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1), the related TNL protocol and the functionality are specified. The TNL provides services for user plane transport and signaling transport.

A gNB may also be connected to a Long Term Evolution (LTE) evolved Node B (eNB) via the X2 interface. Another architectural option is that where an LTE eNB connected to the Evolved Packet Core (EPC) network is connected over the X2 interface with a so called “nr-gNB”. The latter is a gNB not connected directly to a core network and connected via X2 to an eNB for the sole purpose of performing dual connectivity.

The architecture in FIG. 1 can be expanded by spitting the gNB-CU into two entities, namely, a gNB-CU User Plane part (gNB-CU-UP) and a gNB-CU Control Plane part (gNB-CU-CP). The gNB-CU-UP serves the user plane and hosts the Packet Data Convergence Protocol (PDCP) protocol, the gNB-CU-CP serves the control plane and hosts the PDCP and Radio Resource Control (RRC) protocol. For completeness, it should be said that a gNB-DU hosts the Radio Link Control (RLC), Medium Access Control (MAC), and Physical layer (PHY) protocols.

Machine Learning (ML) is a technique that can be used to find a predictive function for a given dataset. The dataset is typically a mapping from a given input to an output. The predictive function (or mapping function) is generated in a training phase. During the training phase, it is typically assumed that both the input and output are known. The test phase comprises predicting the output for a given input. FIG. 2 shows an example of one type of machine learning, namely classification, where the task is to train a predictive function that separates two classes, namely, a circle class and cross class in the illustrated example. In FIG. 2(a), the importance of each sample is equal, which leads to a certain decision region. In contrast, in FIG. 2(b), the samples have different weights (different importance), which leads to another decision region. Note that, in FIG. 2, the weights (importance) of the samples are indicated by the sizes of the respective circles/crosses.

The sample weight can affect the model training, for example, by including the sample weight in the optimization function. A typical optimization is to minimize the mean squared error (MSE) of the model output and the true value, i.e.,

$$M S E = \frac{1}{N} \sum {( f ( x ) - {y}_{true} )}^{2}$$

The sample weight can be included by adding an additional sample weight term (wₛ) as follows:

$$M S E = \frac{1}{N} {\sum }_{s} {{w}_{s} ( f ( {x}_{s} ) - {y}_{true \_ s} )}^{2}$$

where the MSE is calculated for all N stored samples. In general, the trained model accuracy in various output regions is correlated with the weight for each sample, and the number of samples in a certain output range.

There is an ongoing discussion in 3GPP on how to support Artificial Intelligence (AI) and Machine Learning (ML). The proposed study item description in RP-201304 proposes to “Study RAN AI/ML applicability and associated use cases (e.g., energy efficiency, RAN optimization), which is enabled by Data Collection.”

Thus, there is a need for systems and methods for training and using AI or ML models in a cellular communications system such as, e.g., a 3GPP system.

### SUMMARY

Systems and methods are disclosed herein that relate to influencing training of a Machine Learning (ML) model based on a training policy provided by an actor node are disclosed herein. In one embodiment, a method performed by a first node for training a ML model comprises receiving a training policy for a ML model from a second node, the training policy comprising information that indicates two or more accuracy or importance metrics for two or more ranges of values for a variable to be predicted by the ML model. The method further comprises training the ML model based on a training dataset and the training policy. In one embodiment, the first node is either a training and inferring node or a training node that operates to train the ML model, and the second node is an actor node to which predictions made using the ML model are to be provided. In this manner, improved overall performance as compared to existing schemes can be provided since the actor node can influence training of the ML model to be accurate in certain regions where the actor node performs certain actions.

In one embodiment, training the ML model based on the training dataset and the training policy comprises training the ML model using sample weights applied to samples in the training dataset based on the training policy. In one embodiment, each sample in the training dataset comprises one or more input variable values and an actual value of the variable to be predicted by the ML model, the two or more accuracy or importance metrics for the two or more ranges of values for the variable to be predicted by the ML model indicated by the information comprised in the training policy comprise a first accuracy or importance metric for a first range of values for the variable to be predicted by the ML model, the sample weights applied to the samples in the training dataset comprises a first sample weight applied to a first subset of the samples in the training dataset for which the actual value of the variable to be predicted by the ML model is within the first range of values, and the first sample weight is based on the first accuracy or importance metric indicted by the information comprised in the training policy for the first range of values. In one embodiment, the two or more accuracy or importance metrics for the two or more ranges of values for the variable to be predicted by the ML model indicated by the information comprised in the training policy further comprise a second accuracy or importance metric for second range of values for the variable to be predicted by the ML model, the first and second ranges of values are non-overlapping ranges of values, the sample weights applied to the samples in the training dataset comprises a second sample weight applied to a second subset of the samples in the training dataset for which the actual value of the variable to be predicted by the ML mode is within the second range of values, and the second sample weight is based on the second accuracy or importance metric indicted by the information comprised in the training policy for the second range of values. In one embodiment, the first sample weight is different than the second sample weight. In one embodiment, the two or more accuracy or importance metrics for the two or more ranges of values for the variable to be predicted by the ML model are the sample weights.

In one embodiment, the training policy further comprises information that indicates, to the second node, whether to up-sample or down-sample the training dataset for at least one of the two or more ranges of values of the variable to be predicted by the ML model.

In one embodiment, the method further comprises, prior to receiving the training policy from the second node, sending information about the training dataset to the second node. In one embodiment, the information about the training dataset comprises: (a) a total range of values of the variable to be predicted by the ML model comprised the training dataset, (b) all or a subset of all values of the variable to be predicted by the ML model comprised in the training dataset, (c) a Probability Density Function (PDF) or Cumulative Distribution Function (CDF) over all values of the variable to be predicted by the ML model comprised in the training dataset, (d) a number of samples comprised in the training dataset, (e) for each range of values from the two or more ranges of values of the variable to be predicted by the ML model, a number of samples comprised in the training dataset having values of the variable to be predicted by the ML model in the range of values, or (f) a combination of any two or more of (a)-(e).

In one embodiment, the method further comprises sending information about the trained ML model to the second node, receiving an updated training policy from the second node, and updating or re-training the ML model based on the updated training policy.

In one embodiment, a model identity (ID) is associated to the ML model trained based on the training policy.

In one embodiment, the first node is a combined training and inferring node. In one embodiment, the method further comprises generating one or more predicted values for the variable using the ML model and sending the one or more predicted values to the second node. In one embodiment, the method further comprises sending a model ID associated to the ML model that is trained based on the training policy to the second node in association with the one or more predicted values. In one embodiment, the method further comprises receiving the model ID from the second node prior to sending the one or more predicted values to the second node. In one embodiment, the method further comprises sending information that indicates an accuracy of the one or more predicted values to the second node.

In one embodiment, the first node is a training node. In one embodiment, the method further comprises sending the trained ML model to an inferring node. In one embodiment, the method further comprises sending a model ID associated to the ML model that is trained based on the training policy to the second node. In one embodiment, the method further comprises receiving the model ID from the second node prior to sending the trained ML model to the second node.

In one embodiment, the first node is a network node in a cellular communications system. In one embodiment, the first node is a wireless communication device in a cellular communications system.

Corresponding embodiments of a first node for training a ML model are also disclosed herein. In one embodiment, a first node for training a ML model is adapted to receive a training policy for a ML model from a second node, the training policy comprising information that indicates two or more accuracy or importance metrics for two or more ranges of values for a variable to be predicted by the ML model. The first node is further adapted to train the ML model based on a training dataset and the training policy. In one embodiment, a first node for training a ML model comprises one or more communication interfaces comprising either or both of: (i) a network interface and (ii) one or more radio units. The first node further comprises processing circuitry associated with the one or more communication interfaces. The processing circuitry is configured to cause the first node to receive a training policy for a ML model from a second node, the training policy comprising information that indicates two or more accuracy or importance metrics for two or more ranges of values for a variable to be predicted by the ML model. The processing circuitry is further configured to cause the first node to train the ML model based on a training dataset and the training policy.

Embodiments of a method performed by a second node for influencing training of a ML model are also disclosed herein. In one embodiment, a method performed by a second node for influencing training of a ML model comprises sending a training policy for a ML model to a first node, the training policy comprising information that indicates two or more accuracy or importance metrics for two or more ranges of values for a variable to be predicted by the ML model. The method further comprises receiving one or more predicted values for the variable to be predicted by the ML model from either the first node or another node. In one embodiment, the method further comprises performing one or more actions based on the one or more predicted values.

In one embodiment, the first node is either a training and inferring node or a training node that operates to train the ML model, and the second node is an actor node that uses predicted values that are generated using the ML model.

In one embodiment, the two or more accuracy or importance metrics for the two or more ranges of values for the variable to be predicted by the ML model are sample weights to be used for training the ML model.

In one embodiment, the training policy further comprises information that indicates, to the second node, whether to up-sample or down-sample the training dataset for at least one of the two or more ranges of values of the variable to be predicted by the ML model.

In one embodiment, the method further comprises determining the training policy. In one embodiment, the method further comprises receiving, from the first node, information about a training dataset to be used at the first node to train the ML model, and determining the training policy comprises determining the training policy based on the information about the training dataset. In one embodiment, the information about the training dataset comprises: (a) a total range of values of the variable to be predicted by the ML model comprised the training dataset, (b) all or a subset of all values of the variable to be predicted by the ML model comprised in the training dataset, (c) a PDF or CDF over all values of the variable to be predicted by the ML model comprised in the training dataset, (d) a number of samples comprised in the training dataset, (e) for each range of values from the two or more ranges of values of the variable to be predicted by the ML model, a number of samples comprised in the training dataset having values of the variable to be predicted by the ML model in the range of values, or (f) a combination of any two or more of (a)-(e).

In one embodiment, the method further comprises receiving information about the trained ML model from the first node, determining an updated training policy based on the information about the trained ML model, and sending the updated training policy to the first node.

In one embodiment, a model ID is associated to the ML model trained based on the training policy.

In one embodiment, the method further comprises receiving a model ID associated to the ML model that is trained based on the training policy from the first node or the other network node, in association with the one or more predicted values. In one embodiment, the method further comprises sending the model ID to the first node prior to receiving the one or more predicted values.

In one embodiment, the method further comprises receiving information that indicates an accuracy of the one or more predicted values from the first node to the other network node.

In one embodiment, the first node is a network node in a cellular communications system. In one embodiment, the first node is a wireless communication device in a cellular communications system.

Corresponding embodiments of a second node for influencing training of a ML model are also disclosed. In one embodiment, a second node for influencing training of a ML model is adapted to send a training policy for a ML model to a first node, the training policy comprising information that indicates two or more accuracy or importance metrics for two or more ranges of values for a variable to be predicted by the ML model. The second node is further adapted to receive one or more predicted values for the variable to be predicted by the ML model from either the first node or another node.

In one embodiment, a second node for influencing training of a ML model comprises one or more communication interfaces comprising either or both of: (i) a network interface and (ii) one or more radio units. The second node further comprises processing circuitry associated with the one or more communication interfaces. The processing circuitry is configured to cause the second node to send a training policy for a ML model to a first node, the training policy comprising information that indicates two or more accuracy or importance metrics for two or more ranges of values for a variable to be predicted by the ML model. The processing circuitry is further configured to cause the second node to receive one or more predicted values for the variable to be predicted by the ML model from either the first node or another node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the current architecture of the Fifth Generation (5G) Radio Access Network (RAN), which is also referred to as the Next Generation RAN (NG-RAN);

FIG. 2 shows an example of one type of machine learning, namely classification, where the task is to train a predictive function that separates two classes, namely, a circle class and cross class in the illustrated example;

FIGS. 3A and 3B illustrate the operation of a training/inferring node and an actor node to enable training of a Machine Learning (ML) model based on a training policy provided by the actor node in accordance with embodiments of the present disclosure;

FIGS. 4A and 4B illustrate the operation of a training/inferring node and an actor node to enable training of a Machine Learning (ML) model based on a training policy provided by the actor node in accordance with other embodiments of the present disclosure;

FIG. 5 illustrates one example of a cellular communications system according to some embodiments of the present disclosure;

FIGS. 6 and 7 illustrate example embodiments in which the cellular communication system of FIG. 5 is a Fifth Generation (5G) System (5GS);

FIGS. 8, 9, and 10 are illustrations related to example use cases for the process of FIGS. 3A and 3B of FIGS. 4A and 4B in a cellular communications system;

FIG. 11 is a schematic block diagram of a network node according to some embodiments of the present disclosure;

FIG. 12 is a schematic block diagram that illustrates a virtualized embodiment of the network node of FIG. 11 according to some embodiments of the present disclosure;

FIG. 13 is a schematic block diagram of the network node of FIG. 11 according to some other embodiments of the present disclosure;

FIG. 14 is a schematic block diagram of a User Equipment device (UE) according to some embodiments of the present disclosure; and

FIG. 15 is a schematic block diagram of the UE of FIG. 14 according to some other embodiments of the present disclosure.

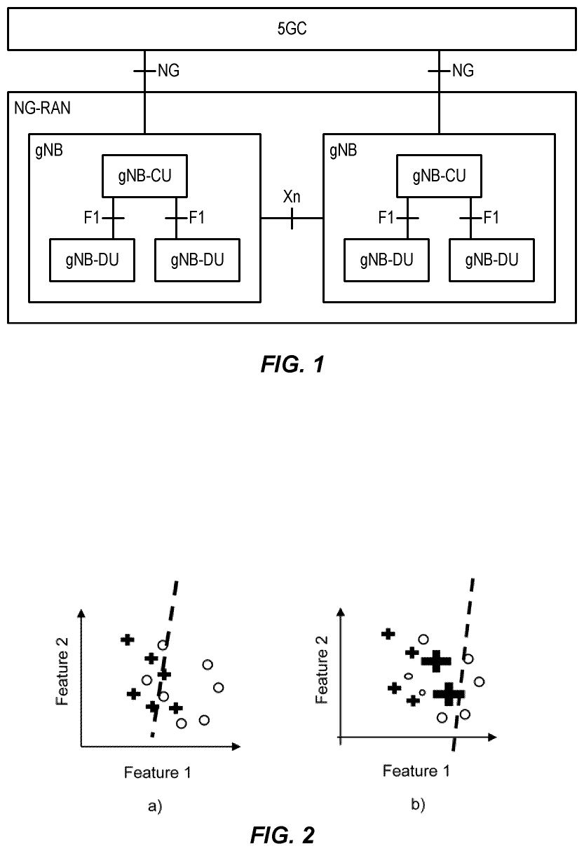

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IOT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There exist certain challenges with conventional Machine Learning (ML) training or adaptation schemes when there is an attempt to apply them to a cellular communications system such as, e.g., a 3GPP system. With the training or adaptation of ML models in the RAN, there is a general challenge since the ML model can be trained and inferred in one network node, but the actuations on the predictions made by the ML model can be performed in another network node (referred to herein as an “actor node”). There is currently no mechanism that enables the actor node that receives predictions made via a ML model to impact the training of the ML model, nor are there any mechanisms for the training node to know how the predictions are used by the actor node. The model built by the training node (e.g., a UE) can be highly accurate in predicting a certain quantity, but less accurate in predicting a certain quantity of high importance to the actor node (e.g., gNB).

In one example, the Operations and Management (OAM) node (actor node) performs actions on the predicted bitrate for a UE, where the predicted bitrate for the UE is received from the gNB (training/inferring node). The OAM node can take actions such as increasing the resources for a network slice serving the UE; however, the resource scaling actions should be major when the predicted UE bitrate is low, in comparison to no action when performance such as the bitrate, latency, or drift from a synchronization clock fulfills the current Service Level Agreement (SLA) associated to the UE. The gNB is not aware of the different actions the OAM can perform when training the bitrate prediction model and can therefore train the model such that it is overly accurate (e.g., unnecessarily accurate) for high-bitrate scenarios which do not affect any action at the OAM, while its accuracy at low bitrates is insufficient when considering the action(s) that can be taken at the OAM node.

Systems and methods are disclosed herein that address the aforementioned or other challenges.

Systems and methods are disclosed herein for sending a training policy, from an actor node, to the training node (or training and inferring node), where the training policy describes how the training node should tradeoff prediction performance for different output ranges when training an associated machine learning (ML) model. In one embodiment, the actor node applies the training policy by controlling sample weights adopted by the training node for different subsets of the training dataset used as inputs to the training process, when training the ML model at the training node. In this embodiment, the training node is able to increase the accuracy of prediction for the ML model in one or more specific output range(s) that are of importance to the actor node.

In one embodiment, the training node sends an accuracy of a prediction made by the ML model at model test or verification phase to the actor node, on a per output basis. Hence, the actor node would know in advance whether the accuracy of the ML model is compliant with the training policy. In addition or alternatively, the accuracy information may be used to determine or update the training policy sent from the actor node to the training node. In one embodiment, the accuracy may be signaled per output value ranges. For example, if the predicted output is throughput, one value of accuracy may be signaled for the range (0, . . . , 100 kilobits per second (Kbps)), a different value of accuracy may be signaled for the range (101 Kbps, . . . , 1000 Kbps), and so on.

In one embodiment, the inferring node (or training and inferring node) signals, to the actor node, an ML model identity (ID) together with the model's predictions. Such ID identifies the ML model instance. For example, if the training node produces or simply uses different instances of the same ML model, each instance performing in a different way, the training node would mark each ML model instance output prediction with a model ID and signal it to the actor node together with the model's output prediction. The actor node may learn with time which ML model instance performs better. As an example, some model instances may perform poorly for the type of output or output ranges that the actor node would consider as the most important to take decisions on e.g., configurations or new policies. The actor node would therefore know which model instance to favor when receiving output predictions from multiple model instances.

In another embodiment, the actor node sends a request to the inference node (or training and inference node) for the inference node to provide output predictions that are produced from a ML model(s) with a specific model ID(s) (e.g., ML model trained in the past based on the same or another training policy). Namely, the actor node may select the ML model instance(s) from which predictions are requested.

In one embodiment, the actor node may itself signal a model ID to the training and/or inferring node, where the model ID is aimed at identifying the model trained according to the training policy (e.g., output accuracy requirements) specified by the actor node.

It needs to be clarified that, for simplicity, the training node and the inferring node appear in some of the description provided herein as a single node, which is denoted as a “training/inferring node”. However, the embodiments described herein are equally applicable to the case where the training node and the inferring node are separate nodes.

Embodiments of the systems and methods disclosed herein may provide a number of advantages over the existing solutions. Embodiments described herein may provide improved overall performance as compared to existing schemes since the actor node can tune the model to be accurate in certain regions where it performs certain actions. This would enable receiving more relevant predictions, leading to better performance. For example, improved performance may be provided for the following example scenarios:
Quality of Service (QOS) or Quality of Experience (QoE) Predictions: The actor node can configure the training node, via a provided training policy, such that the training model should train the model to have accurate predictions for parameters allowing evaluation of missed Service Level Agreement (SLA) fulfillment by defect, and less accurate predictions for parameters allowing evaluation of exceeded SLA fulfillment. This would lead to more accurate predictions in the relevant areas, in comparison to when the training node tries to provide an overall good accuracy for all prediction areas.
Traffic Predictions: In an example, the gNB (actor node) configures a UE (training node) to provide accurate predictions in the areas where the gNB will perform actions, such as:
   configuring Carrier Aggregation (CA) or Dual Connectivity (DC) if the predicted amount of data in the current session is within a certain range and/or the speed of the UE falls in a certain range (or alternatively if the time spent by the UE is a certain cell is higher than a threshold or, as further alternative, if the coverage measurements at the UE indicate a preferred CA or DC configuration), or
   selecting which UEs, among a set of UEs, to configure an inter-frequency handover. Additional possibilities are to select UEs to configure inter-frequency or inter-Radio Access Technology (RAT) measurements that can be used to assist the traffic prediction in a cell.
QoE to Radio Measurement Correlation Predictions: In an example, the gNB (actor node) can configure a UE (training node) with Minimization of Drive Testing (MDT) measurements to be linked to QoE measurements to provide QoE predictions based on radio measurements.
   Embodiments disclosed herein may also reduce the memory needed in the training node by only keeping some samples where the actor node is interested. This would be particularly useful if the model resides at the typically memory constrained UE.

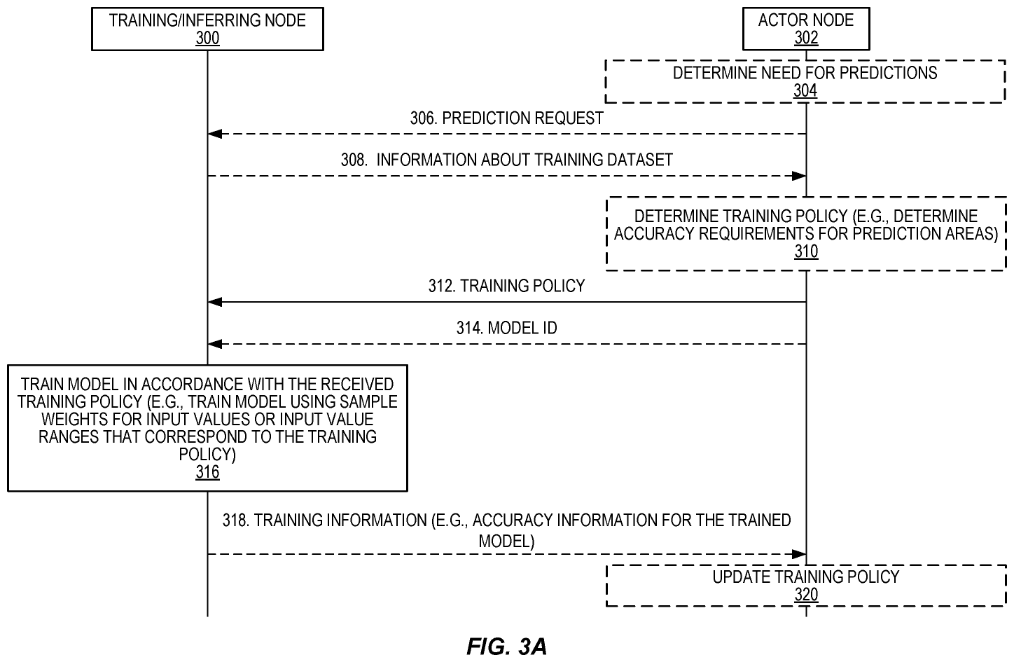

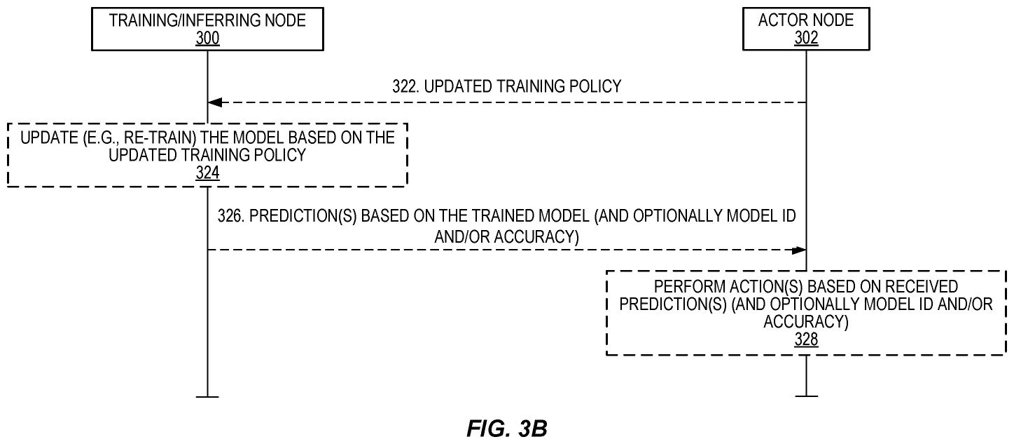

FIGS. 3A and 3B illustrate the operation of a training/inferring node 300 and an actor node 302 in accordance with embodiments of the present disclosure. Note that optional steps are represented by dashed lines/boxes. In one embodiment, the training/inferring node 300 and the actor node 302 are nodes in a cellular communications system. Depending on the use case and scenario, the actor node 302 may be any of network entities such as an Operations and Management (OAM) node, a RAN node (e.g., a Next Generation RAN (NG-RAN) node such as a gNB Central Unit (gNB-CU) or a gNB Distributed Unit (gNB-DU)), a wireless communication device (e.g., a UE) or the like that runs the ML model. The actor node 302 can also comprise, for example, the Service Management and Orchestration (SMO), the near Real-Time RAN Intelligent Controller (RIC), or the Non-Real-Time RIC defined in Open RAN (ORAN). Depending on the use case and scenario, the training/inferring node 300 may be any of network entities such as OAM, RAN node (e.g., NG-RAN node such as, e.g., gNB-CU or gNB-DU), a wireless communication device (e.g., a UE), or the like that trains and infers (executes) the ML model. The training/inferring node 300 can also comprise for example the SMO, the near Real-Time RIC, or the Non-Real-Time RIC defined in ORAN.

As illustrated, the actor node 302 may determine that there is a need for predictions for receiving predictions for a parameter (e.g., bitrate,) (step 304). The “parameter” is also referred to herein as a “variable” that is to be predicted by the ML model. Note that while the description below focuses on a single variable, the ML model may predict one or more variables, as will be understood by those of ordinary skill in the art of ML. The actor node 302 may then send, to the training/inferring node 300 a request for predictions (step 306). The request may include a request for capabilities of the training/inferring node 300 related to training of a ML model based on a training policy provided by the actor node 302. The capabilities can, for example, indicate if the training/inferring node 300 supports receiving and using a training policy from an actor node. Such training policy can comprise up-sampling/down-sampling of its dataset, or changing the importance of a subset of its dataset as described herein.

The training/inferring node 300 may send, to the actor node 302, information about a dataset (i.e., a “training dataset”) to be used for training the ML model (step 308). The training dataset includes many samples, where each sample includes one or more input values and an actual (output) value of the variable (denoted herein as “y”) to be predicted by the ML mode. The information about the training dataset that is sent to the actor node 302 may include:
a range of actual values of the variable y among the samples in the training dataset (where the actual values of the variable y among the samples in the training dataset are denoted herein as y_{training} values),
all or a subset of the y_{training} values among the samples in the training dataset,
a Probability Density Function (PDF) or Cumulative Distribution Function (CDF) over the y_{training} values in the training dataset,
   Note: The actor node 302 may, in some embodiments, set the structure of the PDF or CDF reporting such as, e.g., the granularity of the PDF or CDF. This may be done, e.g., in the request of step 306.
the number of samples in the dataset (and thus the number of y_{training} values in the dataset),
the number of samples in the training dataset having y_{training} values in each of two or more predefined or preconfigured ranges of values for the variable (y) to be predicted by the ML model, or
   Note: In one embodiment, the two or more predefined or preconfigured areas may be configured by, e.g., the actor node 302. This may be done, e.g., in the request of step 306.
a combination of any two or more of the above.
   Note that the information about the training dataset may also include a dataset identity (ID). The dataset ID may be used, e.g., to track the dataset structure over time. This may also be captured by (or alternatively captured by) the model ID of the ML model since a new model can be trained based on receiving new data.

The actor node 302 determines a training policy to be provided to the training/inferring node 300 to influence the training of the ML model (step 310). The actor node 302 may determine the training policy based on the required accuracy of one or more ranges of values output by the ML model that are of importance to the actor node 302—and optionally the information about the training dataset received in step 308. The training policy includes, for each of two or more ranges of values of the variable (y) to be predicted by the ML model (e.g., two or more subsets of the total range of values of y_{training} in the training dataset):
optionally, information that defines the range of values (e.g., a minimum value of the variable (y) in the range and a maximum value of the variable (y) in the range),
an accuracy or importance metric value (e.g., a sample weight value, which is referred to below as a wₛ value) for the respective range of values of the variable (y),
   Note: The accuracy or importance metric value may be indicated as an absolute value (e.g., a value in the range of 0 to 1) or a relative value (e.g., an offset such as an increase or decrease to a reference value, e.g., an initial accuracy or importance value signaled by the training/inferring node 300 as part of the information in step 308).
optionally, an indication to down-sample or up-sample for the respective range of values in the training dataset and, potentially, a value that indicates the amount of down-sampling or up-sampling desired.
   Note that different ranges of values of the variable (y) may have different accuracy or importance metric values. The training policy may further include, in some embodiments, an indication to scale or not to scale the accuracy or importance metric values with the sample distribution of the training dataset.

The actor node 302 sends the training policy for the ML model to the training/inferring node 300 (step 312). In some embodiments, the actor node 302 also sends a model ID to be used for the ML model (or instance of the ML model) trained in accordance with the training policy (step 314).

The training/inferring node 300 trains the ML model in accordance with the training policy (step 316). In one embodiment, training is done by applying weights to the samples in the dataset used for training, where the weights are either directly defined in the training policy (e.g., as the accuracy or importance values) or are determined by the training/inferring node 300 based on the training policy such that the weights applied to the samples in the dataset are determined based on the training policy (e.g., based on the accuracy or importance values included in the training policy for the respective ranges of y values). In one example embodiment, the sample weights are applied in the optimization function used for training of the ML model. In one particular embodiment, the optimization function including the sample weights is defined as:

$$MSE = \frac{1}{N} {\sum }_{s} {{w}_{s} ( f ( {x}_{s} ) - {y}_{true \_ s} )}^{2}$$

where N is the number of samples in the dataset, wₛ is the sample weight for the s-th sample in the dataset, f (xₛ) is a predicted value of the variable y output by the ML model based on a set of input values xₛ for the s-th sample in the dataset, and y_{true_s} is the actual value of the variable y (i.e., the value of y training) for the s-th sample in the dataset. The sample weights wₛ are determined (directly or indirectly) by the training policy provided by the actor node 302.

Once the ML model is trained, the training/inferring node 300 may provide information about the trained ML model (i.e., training information) to the actor node 302 (step 318). This training information may include, for example, accuracy values for the trained ML model for each of two or more values or ranges of values of the predicted variable (y) output by the trained ML model. These accuracy values may be determined based on test samples, which are samples that are not included in the dataset used for training. In one embodiment, the accuracy of the ML model is signaled in the form of a matrix transferring the confusion matrix to the actor node 302. Note that a confusion matrix is a non-limiting example of an accuracy parameter that can be signaled between the training/inferring node 300 and the actor node 302. A confusion matrix for a binary classification ML model is a 2-dimentional array so that each element in the array indicates the accuracy value for predicting true positive, true negative, false positive, and false negative. The confusion matrix is the output of the ML model test/verification phase. The accuracy can be extracted and signaled per value or per range of values of the predicted variable (y).

The actor node 302 may update the training policy based on the received training information (step 320) and provide an updated training policy to the training/inferring node 300 (step 322). For example, if the accuracy of one or more ranges of values output by the ML model that are of importance to the actor node 302 is less than a desired level of accuracy, the actor node 302 may update the training policy to further increase the importance or accuracy of those ranges of values (and possibly decrease the importance or accuracy for one or more other ranges of values in the training policy that are of lesser importance). The training/inferring node 300 then updates or re-trains the ML model based on the updated training policy (e.g., using the same dataset) (step 324). Note that steps 320, 322, and 324 may be repeated.

The training/inferring node 300 uses the trained ML model to provide one or more predictions for the variable (y) and provides the prediction(s) to the actor node 302 (step 326). The training/inferring node 300 may further provide the model ID and/or the accuracy of the prediction(s) to the actor node 302. The actor node 302 performs one or more actions based on the prediction(s) and, optionally, the model ID and/or the accuracy (step 328). For example, the actor node 302 may determine whether to perform one or more actions (e.g., handover of a UE, setup of carrier aggregation or dual connectivity for a UE, or the like) based on the prediction(s).

The actor node 302 may prioritize output predictions from the model trained according to the training policy of the actor node 302 (e.g., according to the actor node's output accuracy requirements), e.g., over predictions received from other models and/or over other types of information. The actor node 302 may additionally or alternatively adjust the training policy (e.g., accuracy requirements) for models to be trained in the future based on the predictions and, optionally, the associated accuracies.

With respect to the embodiments above, the training policy may, in some situations, not be met by the training/inferring node 300. In this case, a number of actions can be taken. For example, in one embodiment, the training/inferring node 300 replies to the actor node 302 with a failure message that indicates, to the actor node 302, that the training policy (e.g., the accuracy requirements) of the actor node 302 is not net. In another embodiment, the training/inferring node 300 replies to the actor node 302 with a failure message and trains the model to meet the training policy to the extent possible (e.g., trains the model to provide the best possible accuracy per model output that can be achieved). In another embodiment, the training/inferring node 300 replies to the actor node 302 with a successful response, but the response indicates the output accuracy that can be achieved and that will be targeted for the predictions specified by the actor node 302.

It should be noted that while, in this embodiment, the training policy is determined by the actor node 302, the training policy may alternatively be determined by a third node (e.g., an OAM node) and provided to the training/inferring node 300 and, optionally, the actor node 302.

It should also be noted that, in one embodiment, the training policy, provided from the actor node 302 to the training/inferring node 300, can be altered due to external weights received by the training/inferring node 300 from an entity other than the actor node 302. An example can be represented by a business-related input that an OAM node may receive from Operations Support Systems (OSS) that may put more emphasis (e.g., larger sample weights) on aspects (e.g., range(s) of values of the predicted output) that are not considered (or considered in different terms) by the actor node 302. For example, in an emergency situation, the weight of a voice service can be further increased compared to a non-emergency situation.

Lastly, it should also be noted that the training/inferring node 300 can, in one embodiment, delete samples of low weight/importance in order to save memory. It can in general select what samples to store based on the configured sample weights. This can in particularly be useful when the ML model resides at and is trained at the UE.

Some additional aspects related to the training policy and the associated signaling will be described. In one embodiment, in addition to or as an alternative to the training policy determined by the actor node 302 in step 310 and provided to the training/inferring node 300 in step 312, an external system, e.g., the OAM, signals the accuracy or importance metric(s) (e.g., sample weight(s) for a certain range(s) of values for the variable (y) predicted by the ML model to both the actor node 302 and the training/inferring node 302. The actor node 302 may, for example, include this signaled accuracy or importance metric(s) in the training policy (or update the training policy to include the signaled accuracy or importance metric(s)). The training/inferring node 300 uses the signaled accuracy or importance metric(s) when training the ML model. If not already included in the training policy, the accuracy or importance metric(s) signaled by the external node may, in some embodiments, override any accuracy or importance metric(s) for the same range(s) of values for the variable (y) included in the training policy received from the actor node 302.

In one embodiment, the actor node 302 itself determines the accuracy or importance metric(s) (e.g., sample weight(s)) for a certain range(s) of values for the variable (y) predicted by the ML model.

In yet another embodiment, the training/inferring node 300 determines initial accuracy or importance metric values for the values or ranges of values of the variable (y) based on dataset to be used for training. For example, these initial metric values may be determined based on the distribution of the training dataset. The initial accuracy or importance metric values may then be sent to the actor node 302, e.g., as part of the information provided to the actor node 302 about the training dataset in step 308. For example, the training/inferring node 300 may use the distribution of the training dataset to derive the accuracy or importance metric values for the different ranges of values of the variable (y) that equalize the prediction performance of the ML model for all output ranges. The training policy determined by the actor node 302 and sent to the training/inferring node 300 may then signal a new accuracy or importance metric value (as absolute values or delta values) for a certain range(s) of values for the variable (y). For example, the training policy may include that the range of values [0,y₁] has sample weight of 1, and the range of values [y₁,y₂] has sample weight 2, whereas all other ranges of values may, e.g., retain the initial sample weight values determined by the training/inferring node 300. The training policy can also include an indication to further scale or not to scale the accuracy or importance metric values with the sample distribution. For example, if there are 2N values in [0,y₁] and N values in [y₁, y₂], training of the ML model will then focus more on the range of [0,y₁], in case of equal weight, since there are more samples in [0,y₁]. One could then further increase the weight by 2 for the training values in [y₁, y₂] in order to mitigate the impact of less samples in that region. The signaling of the accuracy or importance metric can be done so that the corresponding sample weights can provide penalties or trade-offs between different metrics. As an example, the input's time since last packet or packet inter-arrival time can be considered at higher importance for specific services (or packet protocols) and there might be a non-linear (or multi-dimensional) function that the actor node would like the training node to consider. The accuracy or importance metric signaled in the training policy can be adapted with the intensity of the traffic during a period (e.g., following a daily or a weekly pattern).

In another embodiment, the actor node 302, e.g., OAM, can signal the expected accuracy level (via the training policy of step 312) in every range of values of the variable (y) predicted by the ML model. For example, the accuracy level in every range of values can be a value between 0 to 1 indicating the expected accuracy level in a given range or, alternatively, the expected standard deviation of the prediction error in the given area. In response to the expected accuracy level per range of values in the dataset, the training/inferring node 300 can signal the gained accuracy after (re)training the model (via the training information in step 38) to the node requesting the expected accuracy level (e.g., the actor node 312)

In addition, the actor node 302 receiving the accuracy per range of values of the variable (y) can signal, to the training/inferring node 300, to perform a down-sampling or an up-sampling operation on the training dataset to assist the training/inferring node 300 to reach the expected accuracy. This signaling may be made via, e.g., the training policy or updated training policy. Down-sampling and or up-sampling of the dataset can be signaled per range of values of the variable (y). So, the training/inferring node 300 is able to down-sample or up-sample the dataset for the different ranges of values of the variable (y).

In another embodiment, the actor node 302 (or the receiving node) can signal a list of hyper parameters required to train the model to reach the expected accuracy level in each area/sub-area. This signaling may be done via the training policy of step 312.

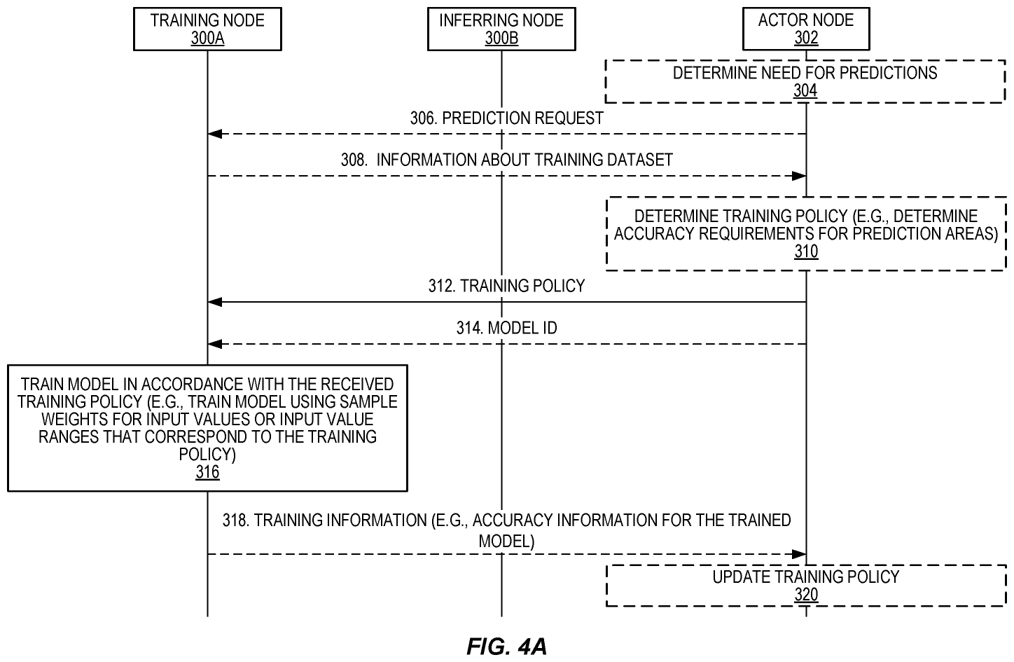

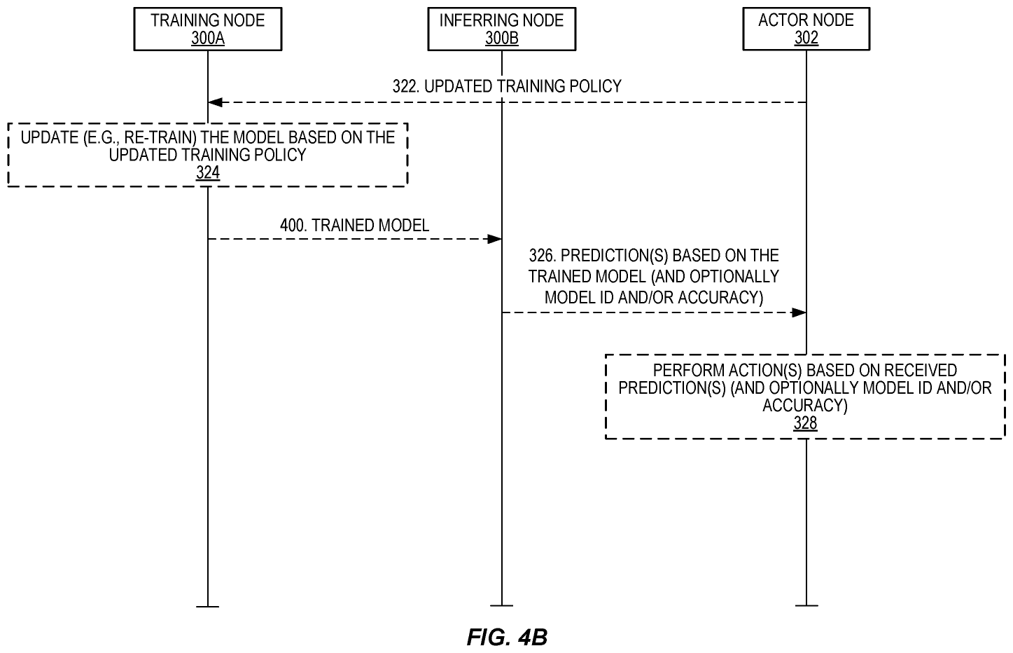

In the example embodiment of FIGS. 3A and 3B, the training node and the inferring node appear as a single node, which is denoted as a “training/inferring node”. However, the embodiments described herein are equally applicable to the case where the training node and the inferring node are separate nodes. In this regard, FIGS. 4A and 4B illustrate a procedure similar to that of FIGS. 3A and 3B but where the training/inferring node 300 is implemented as separate training and inferring nodes 300A and 300B. As illustrated, in such case, the training node 300A, the inferring node 300B, and the actor node 302 may operate, e.g., in the following way:
Steps 304-324 are the same as described above with respect to FIGS. 3A and 3B except that these steps now relate to the training node 300A rather than the training/inferring node 300. As described above, during these steps, the actor node 302 provides a training policy (e.g., indications on accuracy requirements for specific outputs and/or outputs value ranges) to the training node 300A. Optionally, the actor node 302 also signals, to the training node 300A, a model ID aimed at identifying the model developed by the training node 300A according to the provided training policy.
Step 400: In this step, the training node 300A signal the trained model to the inferring node 300B. The model may be signaled together with its model ID.
Step 326: The inferring node 300B signal the output predictions generated using the model to the actor node 302. Such output predictions may be signaled together with the model ID corresponding to the model used to generate the output predictions.
Step 328: The actor node 302 uses the predictions as described herein.

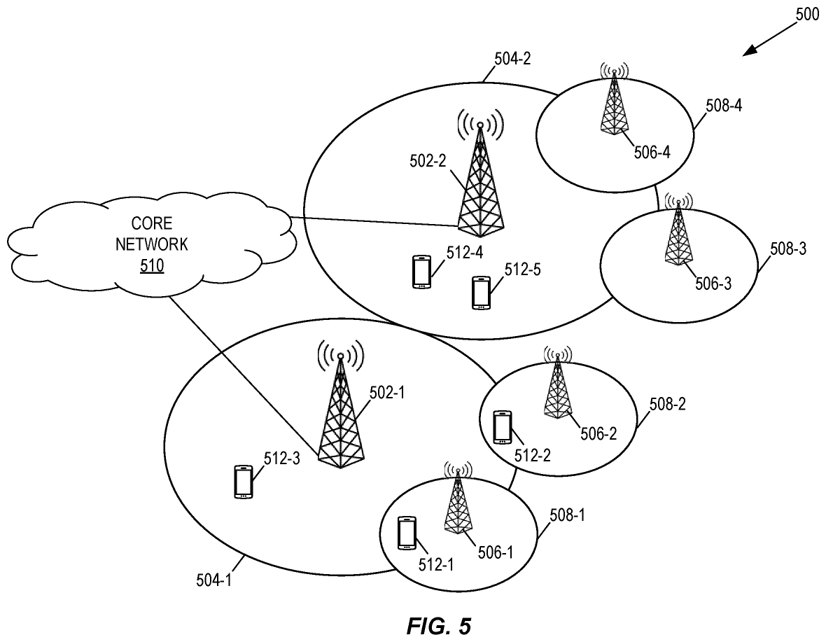

In some embodiments, the procedures described above for training and using a ML model can be implemented in a cellular communications system. FIG. 5 illustrates one example of a cellular communications system 500 in which embodiments of the present disclosure may be implemented. In the embodiments described herein, the cellular communications system 500 is a 5G system (5GS) including a Next Generation RAN (NG-RAN) and a 5G Core (5GC); however, the present disclosure is not limited thereto. In this example, the RAN includes base stations 502-1 and 502-2, which in the 5GS include NR base stations (gNBs), controlling corresponding (macro) cells 504-1 and 504-2. The base stations 502-1 and 502-2 are generally referred to herein collectively as base stations 502 and individually as base station 502. Likewise, the (macro) cells 504-1 and 504-2 are generally referred to herein collectively as (macro) cells 504 and individually as (macro) cell 504. The RAN may also include a number of low power nodes 506-1 through 506-4 controlling corresponding small cells 508-1 through 508-4. The low power nodes 506-1 through 506-4 can be small base stations (such as pico or femto base stations) or Remote Radio Heads (RRHs), or the like. Notably, while not illustrated, one or more of the small cells 508-1 through 508-4 may alternatively be provided by the base stations 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5GS is referred to as the 5GC. The base stations 502 (and optionally the low power nodes 506) are connected to the core network 510.

The base stations 502 and the low power nodes 506 provide service to wireless communication devices 512-1 through 512-5 in the corresponding cells 504 and 508. The wireless communication devices 512-1 through 512-5 are generally referred to herein collectively as wireless communication devices 512 and individually as wireless communication device 512. In the following description, the wireless communication devices 512 are oftentimes UEs, but the present disclosure is not limited thereto.

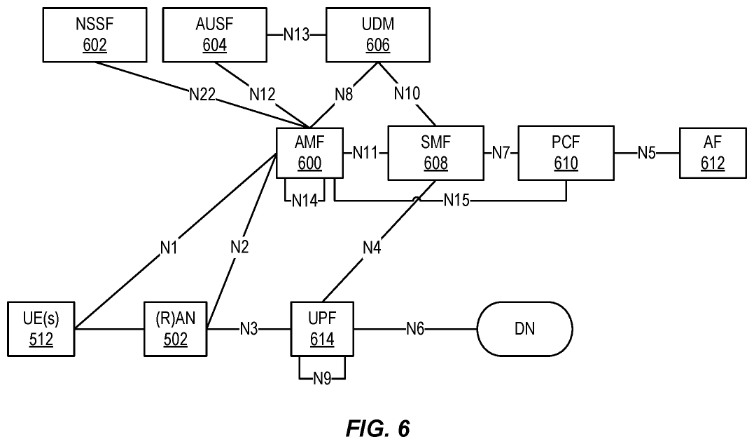

FIG. 6 illustrates a wireless communication system represented as a 5G network architecture composed of core Network Functions (NFs), where interaction between any two NFs is represented by a point-to-point reference point/interface. FIG. 6 can be viewed as one particular implementation of the system 500 of FIG. 5.

Seen from the access side the 5G network architecture shown in FIG. 6 comprises a plurality of UEs 512 connected to either a RAN 502 or an Access Network (AN) as well as an AMF 600. Typically, the R(AN) 502 comprises base stations, e.g. such as eNBs or gNBs or similar. Seen from the core network side, the 5GC NFs shown in FIG. 6 include a NSSF 602, an AUSF 604, a UDM 606, the AMF 600, a SMF 608, a PCF 610, and an Application Function (AF) 612.

Reference point representations of the 5G network architecture are used to develop detailed call flows in the normative standardization. The N1 reference point is defined to carry signaling between the UE 512 and AMF 600. The reference points for connecting between the AN 502 and AMF 600 and between the AN 502 and UPF 614 are defined as N2 and N3, respectively. There is a reference point, N11, between the AMF 600 and SMF 608, which implies that the SMF 608 is at least partly controlled by the AMF 600. N4 is used by the SMF 608 and UPF 614 so that the UPF 614 can be set using the control signal generated by the SMF 608, and the UPF 614 can report its state to the SMF 608. N9 is the reference point for the connection between different UPFs 614, and N14 is the reference point connecting between different AMFs 600, respectively. N15 and N7 are defined since the PCF 610 applies policy to the AMF 600 and SMF 608, respectively. N12 is required for the AMF 600 to perform authentication of the UE 512. N8 and N10 are defined because the subscription data of the UE 512 is required for the AMF 600 and SMF 608.

The 5GC network aims at separating UP and CP. The UP carries user traffic while the CP carries signaling in the network. In FIG. 6, the UPF 614 is in the UP and all other NFs, i.e., the AMF 600, SMF 608, PCF 610, AF 612, NSSF 602, AUSF 604, and UDM 606, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 600 and SMF 608 are independent functions in the CP. Separated AMF 600 and SMF 608 allow independent evolution and scaling. Other CP functions like the PCF 610 and AUSF 604 can be separated as shown in FIG. 6. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

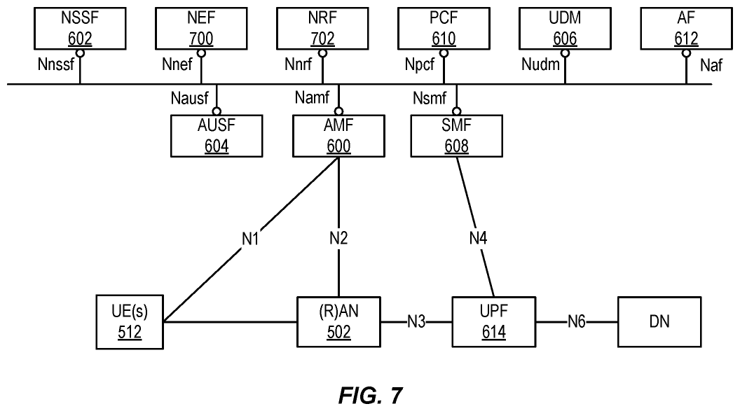

FIG. 7 illustrates a 5G network architecture using service-based interfaces between the NFs in the CP, instead of the point-to-point reference points/interfaces used in the 5G network architecture of FIG. 6. However, the NFs described above with reference to FIG. 6 correspond to the NFs shown in FIG. 7. The service(s) etc. that a NF provides to other authorized NFs can be exposed to the authorized NFs through the service-based interface. In FIG. 7 the service based interfaces are indicated by the letter “N” followed by the name of the NF, e.g. Namf for the service based interface of the AMF 600 and Nsmf for the service based interface of the SMF 608, etc. The NEF 700 and the NRF 702 in FIG. 7 are not shown in FIG. 6 discussed above. However, it should be clarified that all NFs depicted in FIG. 6 can interact with the NEF 700 and the NRF 702 of FIG. 7 as necessary, though not explicitly indicated in FIG. 6.

Some properties of the NFs shown in FIGS. 6 and 7 may be described in the following manner. The AMF 600 provides UE-based authentication, authorization, mobility management, etc. A UE 512 even using multiple access technologies is basically connected to a single AMF 600 because the AMF 600 is independent of the access technologies. The SMF 608 is responsible for session management and allocates Internet Protocol (IP) addresses to UEs. It also selects and controls the UPF 614 for data transfer. If a UE 512 has multiple sessions, different SMFs 608 may be allocated to each session to manage them individually and possibly provide different functionalities per session. The AF 612 provides information on the packet flow to the PCF 610 responsible for policy control in order to support QoS. Based on the information, the PCF 610 determines policies about mobility and session management to make the AMF 600 and SMF 608 operate properly. The AUSF 604 supports authentication function for UEs or similar and thus stores data for authentication of UEs or similar while the UDM 606 stores subscription data of the UE 512. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

Note that the training/inferring node 300, the training node 300A, the inferring node 300B, and the actor node 302 can be implemented as or as part of any of the entities (e.g., base station 502 or other RAN node, UE 512, or NF) depending on the particular use case.

Now, a number of examples that illustrate the process of FIGS. 3A and 3B (and likewise that of FIGS. 4A and 4B) in the context of the cellular communications system 500 are described. These examples are only for illustrative purposes and are not to be constructed to limit the scope of the present disclosure. In the first example below, the training/inferring node 300 is a base station 502 (e.g., gNB) that has collected N samples of Signal to Interference plus Noise Ratio (SINR) versus Bitrate values and intends to build a MO model using Bayessian Ridge Regression to estimate bitrate values from received SINR values. The subsequent examples are for cases in which the training is performed by a UE 512.

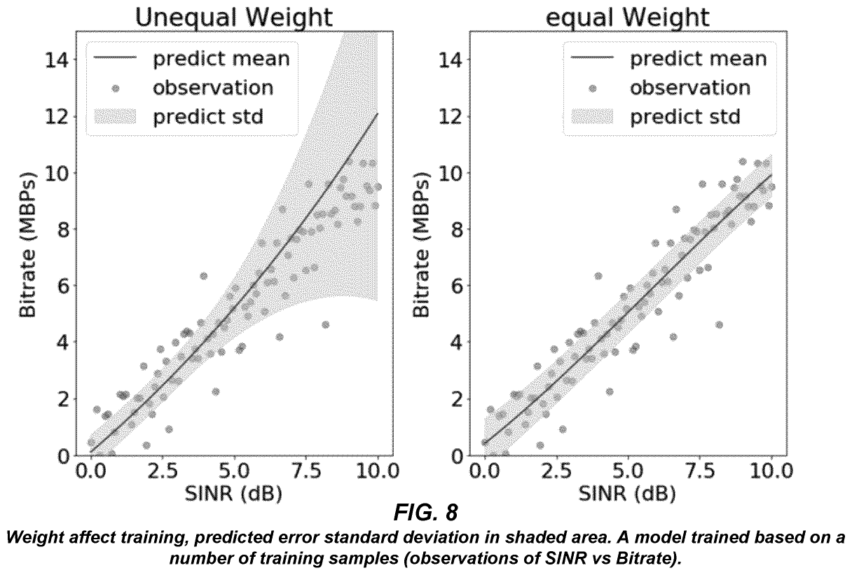

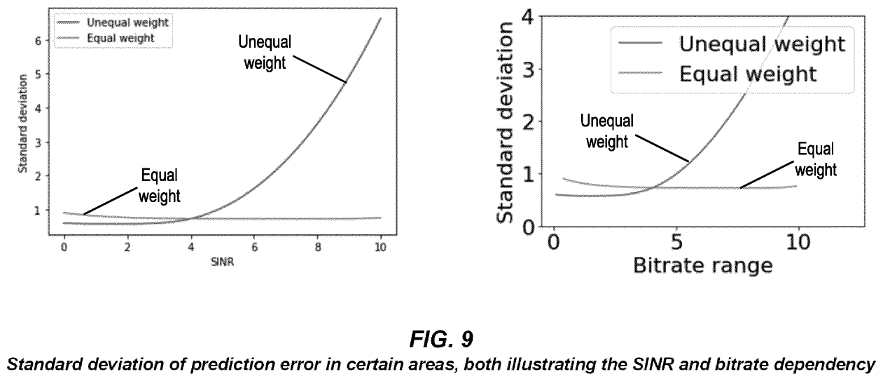

Bitrate Prediction: In this example, the actor node 302 is an OAM node. The OAM might require, for some UEs 512, an accurate bitrate prediction at relatively low values, for example in the range of 0-4 Megabits per second (Mbps), in order to proactively set certain parameters. The OAM node can adapt Radio Resource Management (RRM) policies for the network slice to be configured differently if the predicted bitrate derived by the UE is 1 Mbps, in comparison to 2 Mbps. Similarly, it can decide to not perform any slice policy change if the bitrate is above 4 Mbps. The actor node 302 (i.e., the OAM node in this example) is thus not interested in predictions above such number. It can then, using embodiments of the present disclosure, configure the training/inferring node 300 (i.e., the gNB in this example) with a training policy in the form of, in this example, a sample-weight policy. This is exemplified in FIGS. 8 and 9 where, during training of the ML model, samples in the training dataset having bitrate values in range of 0-4 Mbps were given a 10 times higher weight in comparison to a samples having bitrate values above 4 Mbps. The model used is a Bayesian Ridge Regression, which can be used to output the mean and standard deviation (std) for a certain SINR value as shown, the unequal weight-model is compared with the equal-sample-weighted model. As shown in FIGS. 8 and 9, the accuracies in the low bitrate range are higher for the weighted model in comparison to the equal weighted model, with the cost of less accuracy in the high bitrate region (the region of less importance for the OAM). In this example, the actor node 302 (i.e., the OAM) may optionally signal to the training/inference node 300 (i.e., the gNB) a model ID corresponding to the accuracy requirements specified by the actor node 302 via the training policy, and the training/inference node 300 may signal the same model ID together with the model output results, notifying the actor node 302 that the results were achieved with a model following the accuracy requirements of the actor node 302.

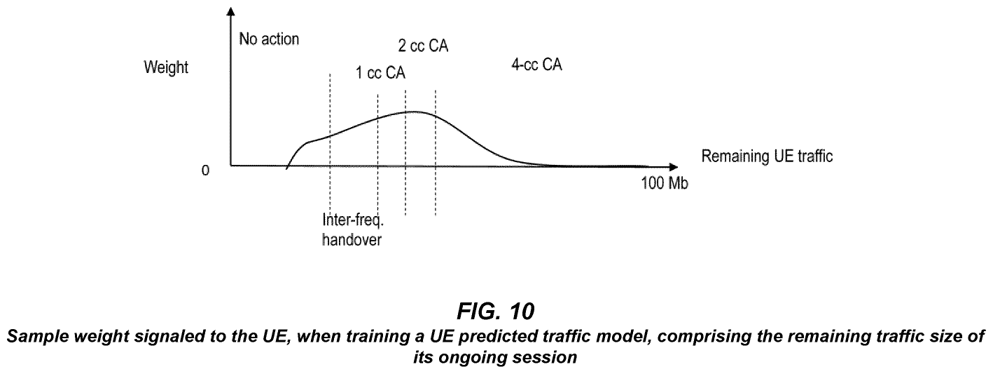

Traffic Prediction Use Case: In this example, the actor node 302 is a base station 502 (e.g., gNB), and the training/inferring node 300 is a UE 512. The network (e.g., gNB) uses the predictions provided by the UE, which include UE-estimated future traffic to be transmitted/received in its current session. The network can take an action such as initiating inter-frequency handovers or activate carrier aggregation, based on the UE predicted traffic. Typically, there is a cost associated to those procedures, and one would like to avoid setting up such features when the UE expected traffic is low. Using embodiments of the present disclosure, the network (gNB) can signal a large weight in the areas (ranges) where it will take its network actions as exemplified in FIG. 10. Actions can comprise activating carrier aggregation with 1/2/4 component carriers (CCs) depending on the predicted remaining UE traffic. The UE can then train a model based on the network provided weights.

The prediction at the UE could be based on the history of data transmissions/receptions of the UE, for example, by using any of the following inputs:
Packet Inter Arrival Time (standard deviation, average . . . )
Number of Packets Up/Down
Total bytes Up/Down
Packet sizes
Time since last packet
Packet protocols (http/voice, . . . )
UE manufacturer
Latency or jitter boundaries
Battery status (in absolute terms or in relative terms)
UE assistance information, e.g., on power consumption or preferred bandwidth
Number of established TCP connections or active IP sessions
Type of Operating System
Number of active PDU Sessions
Number of registered slices (S-NSSAIs)
Type of S-NSSAls
Type of registered network (Home or Visited)

As per previous example, the actor node 302 (i.e., the gNB in this example) may optionally signal to the training/inference node 300 (i.e., the UE in this example) a model ID corresponding to the accuracy requirements specified by the actor node 302, and the training/inference node 300 may signal the same model ID together with the model output results, notifying the actor node 302 that the results were achieved with a model following the accuracy requirements of the actor node 302.

User Plane Optimization for Edge Computing: In a 5GS, based on information below that is collected from the UPF 614 and the AF 612, the Network Data Analytics Function (NWDAF) (i.e., the training/inference node 300 in this example) can provide Service Experience per user plane (UP) path predictions to the requesting Network Function (NF) (consumer), e.g., the SMF 608 (i.e., the actor node 302 in this example).

| | | |
|---|---|---|
| Service | AF | Refers to the QoE as established in the SLA and |
| Experience | | during on boarding. It can be either e.g. MOS or |
| | | video MOS as specified in ITU-T P.1203.3 [16] |
| | | or a customized MOS |
| Performance | AF | The performance associated with the |
| Data | | communication session of the UE with an |
| | | Application Server that includes: Average Packet |
| | | Delay, Average Loss Rate, and Throughput as |
| | | defined in Table 6.49.2-1: Application Server |
| | | Performance Data from EDN network, clause |
| | | 6.49. |
| QoS flow Bit | UPF | The observed bit rate for UL direction; and |
| Rate | | The observed bit rate for DL direction |
| QoS flow | UPF | The observed Packet delay for UL direction; and |
| Packet Delay | | The observed Packet delay for the DL direction |
| Packet | UPF | The observed number of packet transmission |
| transmission | | |
| Packet | UPF | The observed number of packet retransmission |
| retransmission | | |

If the SMF 608 determines that there are more than one Data Network Access Identifier (DNAI) available for the same application, the SMF 608 can also take the Service Experience prediction per UP path from the NWDAF into account to:
(re)select UP paths, including UPF 614 and DNAI e.g., as described in clause 4.3.5 of 3GPP Technical Specification (TS) 23.502;
(re)configure traffic steering, updating the UPF regarding the target DNAI with new traffic steering rules.

Using embodiments of the present disclosure, the SMF 608 can signal the wanted accuracy requirements in the areas of the above listed parameters that are significant for the SMF 608 to take a decision as to ensure the desired Service Experience per UP path. The SMF 608 can also receive these accuracy requirements from the PCF 610.

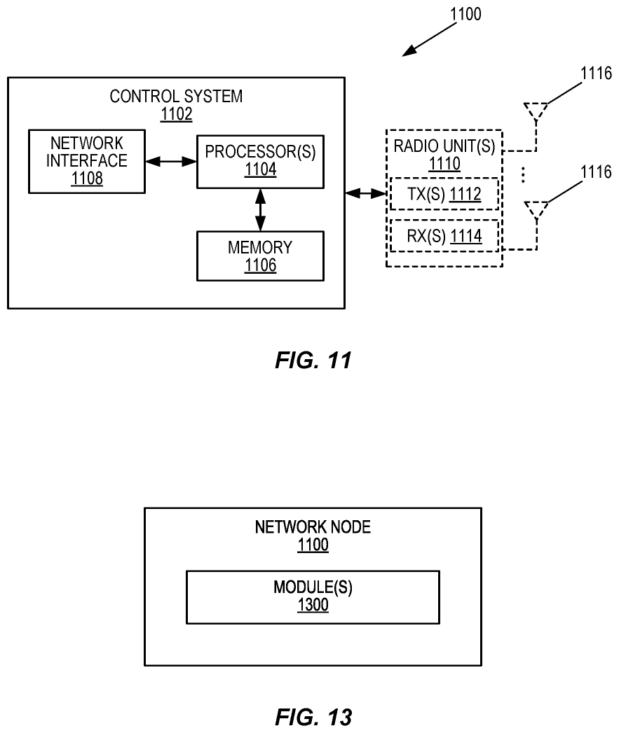

FIG. 11 is a schematic block diagram of a network node 1100 according to some embodiments of the present disclosure. Optional features are represented by dashed boxes. The network node 1100 may be, for example, a base station 502 or 506, a network node that implements all or part of the functionality of the base station 502 or gNB (e.g., a gNB-CU or gNB-DU), or a network node that implements a NF (e.g., NWDAF, UPF, SMF, or the like). The network node 1100 may implement the training/inferring node 300, the training node 300A, the inferring node 300B, or the actor node 302 as described herein. As illustrated, the network node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, if the network node 1100 is a RAN node (e.g., a base station 502), the network node 1100 may include one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of the network node 1100 as described herein (e.g., one or more functions of the training/inferring node 300, the training node 300A, the inferring node 300B, or the actor node 302 as described herein). In some embodiments, the function(s) are implemented in software that is stored, e.g., in the memory 1106 and executed by the one or more processors 1104.

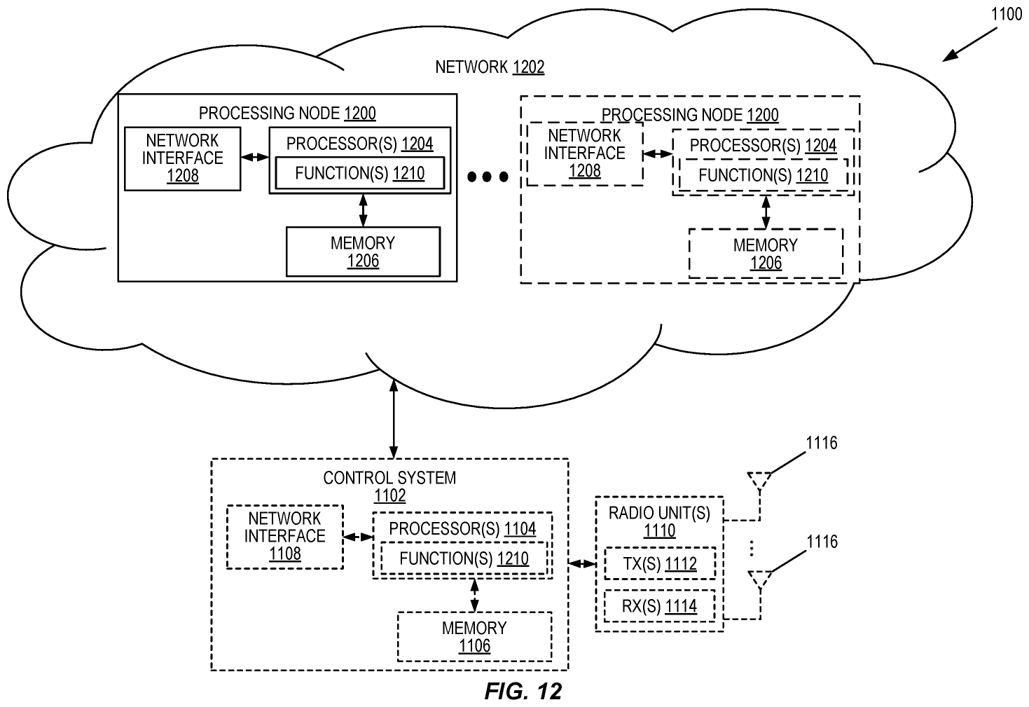

FIG. 12 is a schematic block diagram that illustrates a virtualized embodiment of the network node 1100 according to some embodiments of the present disclosure. Again, optional features are represented by dashed boxes. As used herein, a “virtualized” network node is an implementation of the radio access node 1100 in which at least a portion of the functionality of the network node 1100 is implemented as a virtual component(s) (e.g., via a virtual machine(s) executing on a physical processing node(s) in a network(s)). As illustrated, the network node 1100 includes one or more processing nodes 1200 coupled to or included as part of a network(s) 1202. Each processing node 1200 includes one or more processors 1204 (e.g., CPUs, ASICs, FPGAs, and/or the like), memory 1206, and a network interface 1208. The network node 1100 may, in some embodiments, further include the control system 1102 and/or the one or more radio units 1110, as described above. If present, the control system 1102 or the radio unit(s) are connected to the processing node(s) 1200 via the network 1202.

In this example, functions 1210 of the network node 1100 described herein (e.g., one or more functions of the training/inferring node 300, the training node 300A, the inferring node 300B, or the actor node 302 as described herein) are implemented at the one or more processing nodes 1200 or distributed across the one or more processing nodes 1200 and the control system 1102 and/or the radio unit(s) 1110 in any desired manner. In some particular embodiments, some or all of the functions 1210 of the network node 1100 described herein are implemented as virtual components executed by one or more virtual machines implemented in a virtual environment(s) hosted by the processing node(s) 1200. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of the network node 1100 or a node (e.g., a processing node 1200) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the network node 1100 according to some other embodiments of the present disclosure. The network node 1100 includes one or more modules 1300, each of which is implemented in software. The module(s) 1300 provide the functionality of the network node 1100 described herein (e.g., one or more functions of the training/inferring node 300, the training node 300A, the inferring node 300B, or the actor node 302 as described herein). This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

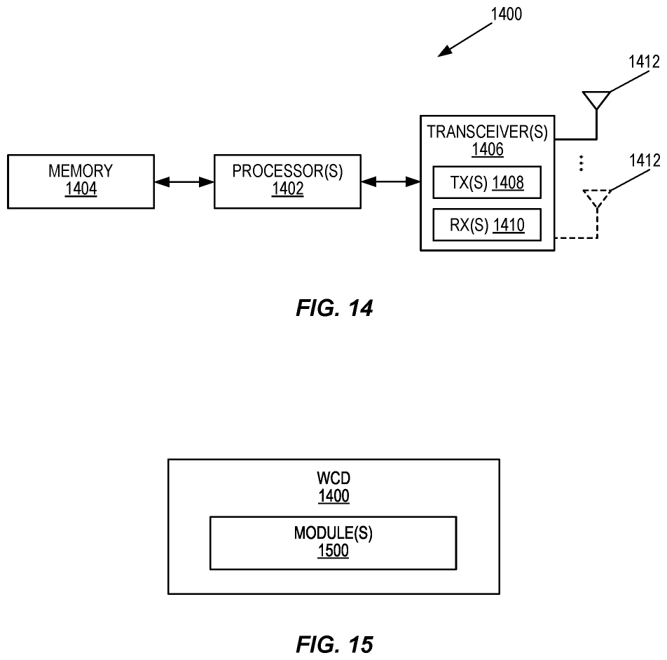

FIG. 14 is a schematic block diagram of a wireless communication device 512 according to some embodiments of the present disclosure. In one embodiment, the wireless communication device 512 performs one or more functions of the training/inferring node 300, the training node 300A, the inferring node 300B, or the actor node 302 as described herein. As illustrated, the wireless communication device 512 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the wireless communication device 512 described above (e.g., one or more functions of the training/inferring node 300, the training node 300A, the inferring node 300B, or the actor node 302 as described herein) may be fully or partially implemented in software that is, e.g., stored in the memory 1404 and executed by the processor(s) 1402. Note that the wireless communication device 512 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 512 and/or allowing output of information from the wireless communication device 512), a power supply (e.g., a battery and associated power circuitry), etc.

In some embodiments, a computer program including instructions which, when executed by at least one processor, causes the at least one processor to carry out the functionality of the wireless communication device 512 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 512 according to some other embodiments of the present disclosure. The wireless communication device 512 includes one or more modules 1500, each of which is implemented in software. The module(s) 1500 provide the functionality of the wireless communication device 512 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DCI Downlink Control Information
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MAC Medium Access Control
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
PDSCH Physical Downlink Shared Channel
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
TCI Transmission Configuration Indicator
TRP Transmission/Reception Point
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a first node for training a machine learning, ML, model, the method comprising:
receiving a training policy for a ML model from a second node, the training policy comprising information that indicates two or more accuracy or importance metrics for two or more ranges of values for a variable to be predicted by the ML model; and
training the ML model based on a training dataset and the training policy.

2. (canceled)

3. The method of claim 1, wherein training the ML model based on the training dataset and the training policy comprises training the ML model using sample weights applied to samples in the training dataset based on the training policy.

4. The method of claim 3 wherein:
each sample in the training dataset comprises one or more input variable values and an actual value of the variable to be predicted by the ML model;
the two or more accuracy or importance metrics for the two or more ranges of values for the variable to be predicted by the ML model indicated by the information comprised in the training policy comprise a first accuracy or importance metric for a first range of values for the variable to be predicted by the ML model;
the sample weights applied to the samples in the training dataset comprises a first sample weight applied to a first subset of the samples in the training dataset for which the actual value of the variable to be predicted by the ML model is within the first range of values; and
the first sample weight is based on the first accuracy or importance metric indicted by the information comprised in the training policy for the first range of values.

5. The method of claim 4 wherein:
the two or more accuracy or importance metrics for the two or more ranges of values for the variable to be predicted by the ML model indicated by the information comprised in the training policy further comprise a second accuracy or importance metric for second range of values for the variable to be predicted by the ML model, the first and second ranges of values being non-overlapping ranges of values; and
the sample weights applied to the samples in the training dataset comprises a second sample weight applied to a second subset of the samples in the training dataset for which the actual value of the variable to be predicted by the ML mode is within the second range of values; and
the second sample weight is based on the second accuracy or importance metric indicted by the information comprised in the training policy for the second range of values.

6. (canceled)

7. The method of claim 3 wherein the two or more accuracy or importance metrics for the two or more ranges of values for the variable to be predicted by the ML model are the sample weights.

8. The method of claim 1 wherein the training policy further comprises information that indicates, to the second node, whether to up-sample or down-sample the training dataset for at least one of the two or more ranges of values of the variable to be predicted by the ML model.

9. The method of claim 1 further comprising, prior to receiving the training policy from the second node, sending information about the training dataset to the second node.

10. (canceled)

11. The method of claim 1 further comprising:
sending information about the trained ML model to the second node;
receiving an updated training policy from the second node; and
updating or re-training the ML model based on the updated training policy.

12. (canceled)

13. The method of any of claims 1 to 12 claim 1 wherein the first node is a combined training and inferring node, further comprising:
generating one or more predicted values for the variable using the ML model; and
sending the one or more predicted values to the second node.

14. (canceled)

15. The method of claim 13 further comprising sending a model identity, ID, associated to the ML model that is trained based on the training policy to the second node in association with the one or more predicted values.

16. (canceled)

17. (canceled)

18. The method of claim 1 wherein the first node is a training node, further comprising sending the trained ML model to an inferring node.

19. (canceled)

20. The method of claim 18 further comprising sending a model identity, ID, associated to the ML model that is trained based on the training policy to the second node.

21-25. (canceled)

26. A first node for training a machine learning, ML, model, the first node comprising:
one or more communication interfaces; and
processing circuitry associated with the one or more communication interfaces, the processing circuitry configured to cause the first node to:
receive a training policy for a ML model from a second node, the training policy comprising information that indicates two or more accuracy or importance metrics for two or more ranges of values for a variable to be predicted by the ML model; and
train the ML model based on a training dataset and the training policy.

27. (canceled)

28. A method performed by a second node for influencing training of a machine learning, ML, model, the method comprising:
sending a training policy for a ML model to a first node, the training policy comprising information that indicates two or more accuracy or importance metrics for two or more ranges of values for a variable to be predicted by the ML model; and
receiving one or more predicted values for the variable to be predicted by the ML model from either the first node or another node.

29. (canceled)

30. (canceled)

31. The method of claim 28 wherein the two or more accuracy or importance metrics for the two or more ranges of values for the variable to be predicted by the ML model are sample weights to be used for training the ML model.

32. The method of claim 28 wherein the training policy further comprises information that indicates, to the second node, whether to up-sample or down-sample the training dataset for at least one of the two or more ranges of values of the variable to be predicted by the ML model.

33. The method of claim 28 further comprises determining the training policy, further comprising:
receiving, from the first node, information about a training dataset to be used at the first node to train the ML model; and
wherein determining the training policy comprises determining the training policy based on the information about the training dataset.

34. (canceled)

35. (canceled)

36. The method of claim 28 further comprising:
receiving information about the trained ML model from the first node;
determining an updated training policy based on the information about the trained ML model; and
sending the updated training policy to the first node.

37. (canceled)

38. The method of claim 28 further comprising receiving a model identity, ID, associated to the ML model that is trained based on the training policy from the first node or the other network node, in association with the one or more predicted values.

39-44. (canceled)

45. A second node for influencing training of a machine learning, ML, model, the second node comprising:
one or more communication interfaces comprising either or both of: (i) a network interface and (ii) one or more radio units; and
processing circuitry associated with the one or more communication interfaces, the processing circuitry configured to cause the first node to:
send a training policy for a ML model to a first node, the training policy comprising information that indicates two or more accuracy or importance metrics for two or more ranges of values for a variable to be predicted by the ML model; and
receive one or more predicted values for the variable to be predicted by the ML model from either the first node or another node.

46. (canceled)
